(19) United States
(12) Patent Application Publication
(10) Pub. No.: US 2007/0183289 A1
(43) Pub. Date: Aug. 9, 2007

(54) Method for recording information on super-resolution optical recording medium and super-resolution optical recording medium

(75) Inventors: Narutoshi Fukuzawa, Tokyo (JP); Takashi Kikukawa, Tokyo (JP); Tatsuhiro Kobayashi, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/699,439

(22) Filed: Jan. 30, 2007

(30) Foreign Application Priority Data
Feb. 3, 2006 (JP) 2006-026729

(51) Int. Cl. G11B 7/0045; G11B 7/24

(52) U.S. Cl. 369/59.11; 369/275.1

(57) ABSTRACT

When a recording mark and a space, each having a size depending on a modulation code corresponding to information to be recorded, are formed in a super-resolution optical recording medium which has at least a substrate and a recording layer, a super-resolution layer, and a light transmitting layer on the substrate, a space shorter than at least the resolution limit of a reproducing optical system is formed so that the space has a crescent shape when plan view from top surface and a convex section when viewed in a direction normal to a track, thereby allowing high carrier-to-noise ratio (CNR) recording of information.

### BACKGROUND OF THE INVENTION

1. Field of the Invention

The present invention relates to a method for recording information on an optical recording medium in which irradiation of a reproducing light beam on a recording mark and a space which are formed therein allows reproduction of information, especially on a super-resolution optical recording medium in which a recording mark and a space, each of which has a length equal to or less than the resolution limit of a reproducing optical system, can be reproduced, and relates to a super-resolution optical recording medium on which information is recorded by the method.

2. Description of the Related Art

In recent years, super-resolution optical recording media have been proposed in which a train of a recording mark and a space, which are each shorter than the diffraction limit of a reproducing optical system, can be reproduced as described in, for example, Japanese Patent Laid-Open Publication No 2003-6872.

In general, the train of recording marks which are arranged at a period equal to or less than a specific recording-mark period in a general optical recording medium cannot be read by any optical reproducing method. The length of the specific recording-mark period is called the diffraction limit. In a reproducing optical system with a wavelength λ and a numerical aperture NA, the diffraction limit is represented by λ/NA/2, and the length of the recording mark or space is represented by λ/NA/4 if the recording mark and the space have the same length in a cycle. This length is called the resolution limit.

Therefore, a shorter wavelength λ and/or a larger numerical aperture NA result in a small resolution limit, thereby improving the recording density. However, further shortening of the wavelength and further extending of the numerical aperture to increase the recording density are reaching their limits. The super-resolution optical recording medium as described above is a technology that allows a recording mark and a space which are shorter than λ/NA/4 to be reproduced, achieving further high-density recording without shortening the wavelength λ and extending the numerical aperture NA.

The general optical recording medium as described above has a phase-change recording layer, so that the recording mark and the space are not deformed by recording as disclosed, for example, in “Scanning Probe Microscope Observation of Recorded Marls in Phase Change Disks,” Takashi Kikukawa and Hajime Utsunomiya, Microsc. Microanal., 7 (2001), pp 363-367.

### SUMMARY OF THE INVENTION

In view of the foregoing problems, various exemplary embodiments of this invention provide an information recording method for a super-resolution optical recording medium capable of bringing about a further increase in the recording density, and a super-resolution optical recording medium on which information is recorded by the method.

As a result of an intensive study, the inventor has found that the method according to the present invention allows formation of a space shorter than at least the resolution limit by irradiation of a recording laser beam so that the space has a crescent shape when plan view from top surface and a convex section when viewed in a direction normal to the track and thus allows high carrier-to-noise ratio (CNR) recording of information.

In summary, the above-described objectives are achieved by the following embodiments of the present invention.

(1) An information recording method for irradiating with a recording laser beam a super-resolution optical recording medium which has at least a substrate and a recording layer, a super-resolution layer, and a light transmitting layer on the substrate so that a recording mark and a space, each having a size depending on a modulation code corresponding to information to be recorded, are formed while at least a shortest mark and space corresponding to the modulation code have a size equal to or less than a resolution limit of a reproducing optical system and can be reproduced in the reproducing optical system, wherein the recording layer is made from a material capable of changing its optical constant and volume when irradiated with the recording laser beam, and is irradiated with the recording laser beam so that the space having the size equal to or less than the resolution limit has a crescent shape when plan view from top surface and a convex section when viewed in a direction normal to a track.

(2) A super-resolution optical recording medium, comprising: at least a substrate, a recording layer, a super-resolution layer, and a transparent layer on the substrate; and a recording mark and a space, each having a size depending on a modulation code corresponding to information to be recorded, wherein at least a shortest mark and space corresponding to the modulation code is recorded so as to have a size equal to or less than a resolution limit of a reproducing optical system and so as to be reproduced in the reproducing optical system, wherein the space having the length equal to or less than the resolution limit of the optical reproducing system is formed to have a crescent shape when plan view from top surface and a convex section when viewed in a direction normal to a track.

According to the invention, information can be recorded at high CNR by forming the space shorter than at least the resolution limit by irradiation of the recording laser beam so that the space has a crescent shape when plan view from top surface and a convex section when viewed in the direction normal to the track.

### BRIEF DESCRIPTION OF THE DRAWINGS

FIG. 1 is a cross-sectional view schematically showing a super-resolution optical recording medium in accordance with an exemplary embodiment of the present invention;

FIG. 2 is a block diagram showing an information recording and reproducing apparatus for recording and reproducing information on and from the super-resolution optical recording medium;

FIG. 3 includes plan views schematically showing the shortest recording mark which is formed in a recording layer of the super-resolution optical recording medium;

FIG. 4 is a diagram showing a relationship between recording power and CNR of a 2T mark train which is recorded on a super-resolution optical recording medium of Example 1;

FIG. 5 is a cross-sectional diagram showing concave and convex of the 2T mark train; and

FIG. 6 is a diagram showing a plan-view AFM (atomic force microscope) image of 2T mark trains which are recorded on the super-resolution recording medium by the recording laser beam with various graduated recording power.

### DETAILED DESCRIPTION OF THE PREFERRED EMBODIMENTS

An information recording method for a super-resolution optical recording medium in accordance with a preferred embodiment includes irradiating with a recording laser beam a recording layer of the super-resolution optical recording medium which has at least a substrate and the recording layer, a super-resolution layer, and a transparent layer located on the substrate so that recording marks, each having a size depending on modulation codes corresponding to information to be recorded, are formed in the recording layer while spaces where no recording marks are formed are provided, and so that at least the shortest mark and space of the recording marks and spaces corresponding to the modulation codes have a size equal to or less than the resolution limit of a reproducing optical system and can be reproduced in the reproducing optical system. In this method, the space having a size equal to or less than the resolution limit of the reproducing optical system has a crescent shape when plan view from top surface and a convex section when viewed in a direction normal to a track by the irradiation of the recording laser beam. The marks and spaces having a fixed length or various lengths are formed in the super-resolution optical recording medium according to an appropriate modulation code. The shape of the spaces is determined from an AFM image of the surface which has been exposed after removal of the transparent layer.

### First Exemplary Embodiment

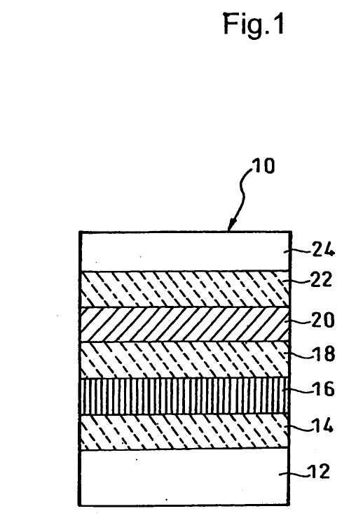

A first exemplary embodiment of the present invention will now be described in detail with reference to FIGS. 1 to 3. As shown in FIG. 1, a super-resolution optical recording medium 10 according to the present invention is configured to include a first dielectric layer 14, a super-resolution layer 16, a second dielectric layer 18, a recording layer 20, a third dielectric layer, and a transparent layer 24, all of which are formed in this order on a substrate 12.

The substrate 12 is made of, for example, polycarbonate. The first dielectric layer 14, the second dielectric layer 18, and the third dielectric layer 22 contain a semiconductor, metal oxide, sulfide, or combination thereof such as ZnS—SiO₂, ZnS, and ZnO.

The recording layer 20 is made of a material such as PtOx whose optical constant changes due to thermal decomposition to platinum and oxygen, but is not limited to PtOx. Any materials whose optical constants and volume change by irradiation of the recording laser beam and in which the recording marks formed therein are not erased by irradiation of the reproducing laser beam, are also appropriate to form the recording layer 20.

The super-resolution layer 16 is made of a super-resolution material capable of reproducing a recording mark having a length equal to or less than λ/4NA, and is made of either one element selected from the group consisting of Sb, Bi, and Te or a compound containing at least one element selected from the group consisting of Sb, Bi, Te, Zn, Sn, Ge, and Si, and for example, a compound containing some elements of the group: Sb—Zn, Te—Ge, Sb—Te, Sb—Bi, Bi—Te, or Sb—Bi—Te.

Other material may be used as or included in the super-resolution layer 16 as long as the material appears opaque to the reproducing laser beam and has a low thermal conductivity.

A mixture of Ag or In and one or more of the materials as described above may be used as the super-resolution layer 16.

The super-resolution optical recording medium 10 was prepared in which (ZnS)₈₅(SiO₂)₁₅ was used as the materials of the first dielectric layer 14, the second dielectric layer 18, and the third dielectric layer 22, Sb₇₅Te₂₅ as the super-resolution layer 16, and PtOx as the recording layer 20.

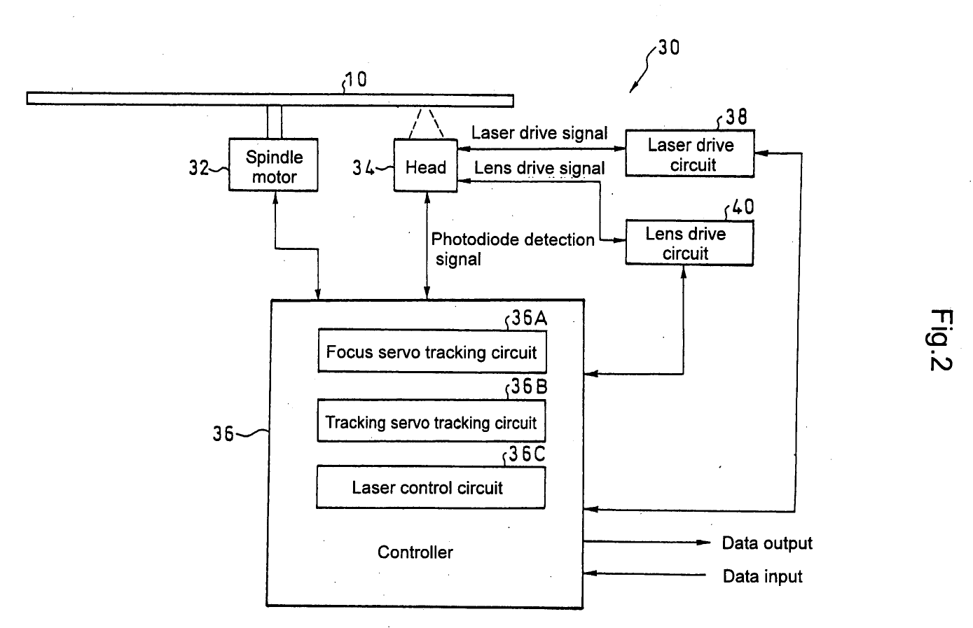

An information recording and reproducing apparatus 30 as shown in FIG. 2 can record and reproduce information on and from the super-resolution optical recording medium 10 having the aforementioned structure.

The information recording and reproducing apparatus 30 is configured to include a spindle motor 32 for turning the super-resolution optical recording medium 10, a head 34 for irradiating the super-resolution optical recording medium 10 with a laser beam, a controller 36 for controlling the head 34 and the spindle motor 32, a laser drive circuit 38 that supplies a laser drive signal for modulating the laser beam from the head 34 into a pulse train, and a lens drive circuit 40 that supplies a lens drive signal to the head 34.

The controller 36 includes a focus servo tracking circuit 36A, a tracking servo tracking circuit 36B, and a laser control circuit 36C.

The laser control circuit 36C generates the laser drive signal supplied from the laser drive circuit 38. Specifically, the laser control circuit 36C is configured to generate, on data recording, an appropriate laser drive signal based on recording-condition setting information which is recorded on the target super-resolution optical recording medium, and to generate, on data reproduction, a laser drive signal so that the power of the laser beam becomes a predetermined power according to the type of target super-resolution optical recording medium used.

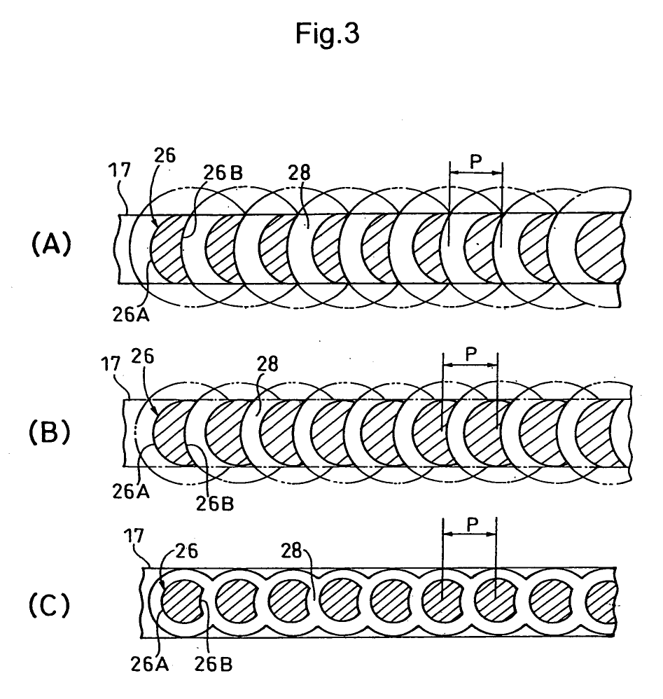

Pairs of the shortest recording mark and space (2T) were formed sequentially in the recording layer 20 along a track 17 with the recording power of the recording laser beam varied by the information recording and reproducing apparatus 30, and the transparent layer 24 was then removed to allow for observation of the surface. The spaces observed from above by an AFM had a crescent shape when plan view from top surface as shown in FIG. 3. Specifically, each crescent top surface had a convex circular arc 26A at its head side and a concave circular arc 26B at its tail side in the moving direction of the recording laser beam.

Since an AFM image shows an image on which a topography (concave and convex) on a surface is reflected, it is clearly illustrated that deformation caused by recording results in formation of a recording mark as well as a space that has a crescent shape when plan view from top surface and an upward convex section (protrusion to the laser beam incident side) when viewed in a direction normal to the track 17.

The mechanism of formation of the space portion that has a crescent shape when plan view from top surface and a convex section when viewed in a direction normal to the track 17 is still unclear here. However, it is assumed that the space is formed together with the recording mark.

FIG. 3 shows super-resolution marks and spaces, each having a length of 75 nm (<λ/NA/4) in an optical system with λ=405 nm and NA=0.85, formed sequentially, but the present invention is not limited thereto. The super-resolution optical recording medium 10 may have a space having a length equal to or less than the resolution limit and other than 75 nm, or may have not only marks and spaces each having the same length but also spaces equal to or less than the resolution limit of the reproducing optical system between marks of various lengths.

For example, when a (1, 7) modulation code is used where T=37.5 nm, one medium has seven types of spaces which are different in length, being 2T (=75 nm), 3T (=112.5 nm), 4T (=150 nm), 5T (=187.5 nm), 6T (=225 nm), 7T (=262.5 nm) and 8T (=300 nm). Even when a space having a length of 75 nm is between marks each having a length of 300 nm, such a structure where the space has a crescent shape when plan view from top surface and a convex section when viewed in a direction normal to the track 17 can also provide good characteristics.

The recording marks 26 and the spaces 28 having shapes as shown in FIG. 3 were formed only when the power of the recording laser beam was in a certain range. Only the laser beam with power in the appropriate range can form the space that has a crescent shape when plan view from top surface and a convex section when viewed in a direction normal to the track 17. In particular, in order to obtain good CNR characteristics, it is preferable to set the reproducing power to two to six times that of the conventional medium (0.3 to 0.7 mW) and to set the ratio of the recording power to the reproducing power to a certain range (2.7 to 5.0).

### EXAMPLE 1

A super-resolution optical recording medium of Example 1 was formed of a reflective film made from an Ag alloy film with a thickness of 40 nm, a first dielectric layer made of ZnS—SiO₂ (ZnS:SiO₂=85:15) with a thickness of 80 nm, a super-resolution layer made of Sb₇₅Te₂₅ with a thickness of 10 nm, a second dielectric layer made of ZnS—SiO₂ (ZnS:SiO₂=85:15) with a thickness of 40 nm, a recording layer made of PtOx with a thickness of 4 nm, a third dielectric layer made of ZnS—SiO₂ (ZnS:SiO₂=85:15) with a thickness of 90 nm, and a light transmitting layer with a thickness of 0.1 mm, all of which were formed in this order on a polycarbonate substrate.

It is assumed that in the medium having the structure as described above, decomposition of PtOx (being the recording layer) to Pt and O₂ by recording forms a recording mark by deformation, allowing reproduction of the recording mark equal to or less than the resolution limit based on an optical change in Sb₇₅Te₂₅ (being the super-resolution layer), i.e., providing super-resolution reproduction. It should be appreciated that the structure and materials of the medium that allows the formation of recording marks by deformation and the super-resolution reproduction are not limited to those as described above. The medium may use a recording layer in which a space having a length equal to or less than the resolution limit of a reproducing optical system has a crescent shape when plan view from top surface and a convex section when viewed in a direction normal to the track 17 and a super-resolution layer which allows super resolution accordingly.

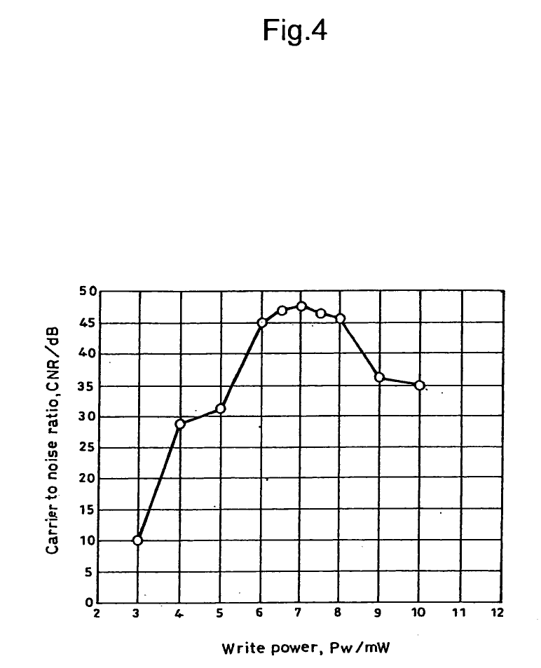

The recording marks each having a length of 75 nm (with a beam spot diameter of approximately 480 nm) were sequentially formed using eight different steps of power for the recording laser beam in a super-resolution optical recording medium formed under the conditions as described above, and the marks were then reproduced using an appropriate power of 2.2 mW higher than the reproducing power used in a current commercial general optical disc. As a result, the CNR (dB) of the mark train was obtained as shown in Table 1 and FIG. 4. The ratio of suitable recording power to reproducing power was in a range of 2.7 to 5.0.

TABLE 1

| Pw (mW) | CNR (dB) |
|---|---|
| 0.0 | — |
| 3.0 | 10.1 |
| 4.0 | 28.9 |
| 5.0 | 31.3 |
| 6.0 | 44.9 |
| 7.0 | 47.5 |
| 8.0 | 45.5 |
| 9.0 | 36.2 |
| 10.0 | 35.1 |

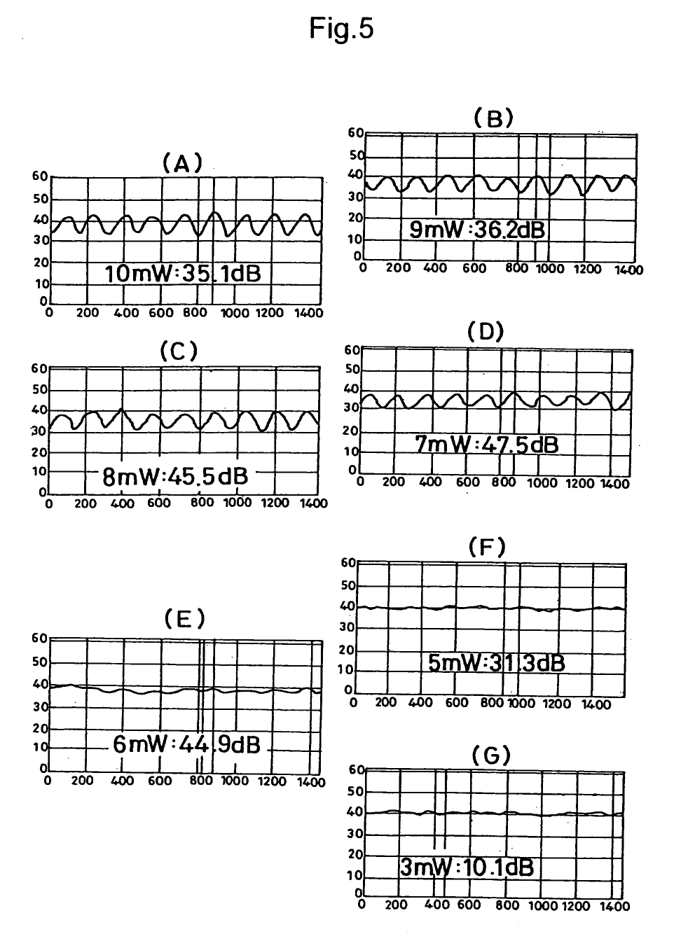

The transparent layer 24 was removed from the super-resolution optical recording medium 10 after the formation of the recording marks. The remaining portion was then observed by the AFM, and concave-convex profiles on a straight line scanning through the center portion of the recording marks were obtained, as shown in FIG. 5. In the concave-convex profiles, each of the convex portions represents a space. As can be seen from the profiles, the regions indicating high CNR correspond to the convex sections of the spaces when viewed in a direction normal to the track.

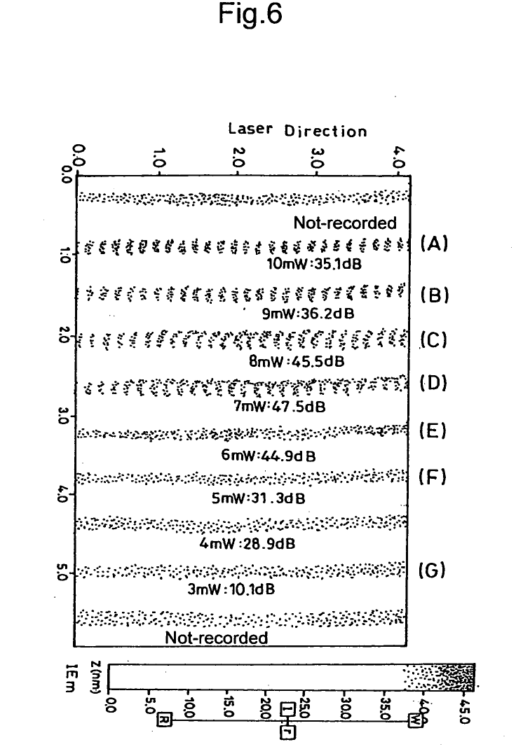

Plan-view AFM images of the formed recording regions for each recording power were obtained, as shown in (A) to (G) of FIG. 6. The concave and convex profiles can be seen from shading of the AFM images. Specifically, very dark portions represent the convex portions, and light portions represent the concave portions. The crescent shape of the convex space portions shows high CNR conditions.

The concave and convex sections in the concave-convex profiles at laser beam recording powers of more than about 6 mW change shape as the power increases, as shown in FIG. 5. However, the depth of the sections (concave and convex) at a power of about 10 mW reaches a maximum limit. This is because the forward recording mark overlaps the backward recording mark. The portion of the recording mark 26 is dug by irradiation of the laser beam using a more than adequate power level, and approximately the same volume as the portion dug out is thus piled up around it, so that a space 28 higher than the recording mark 26 is formed.

In the AFM images shown in FIG. 6, it was confirmed that the moving direction of the recording laser beam was from the left to the right of the figure, in other words, the left of the figure was the head side of the track and the right was the tail side of the track. This was determined by adjusting the incident direction of the recording laser beam, the rotation direction of the medium at recording, the fixed direction of the medium at AFM observation, and the scanning direction of the probe of the AFM.

### EXAMPLE 2

A super-resolution optical recording medium of Example 2 was formed from a reflective layer made from an Ag alloy film with a thickness of 40 nm, a first dielectric layer made of ZnS—SiO₂ (ZnS:SiO₂=85:15) with a thickness of 80 nm, a super-resolution layer made of Sb₅₈Te₄₂ with a thickness of 15 nm, a second dielectric layer made of ZnS—SiO₂ (ZnS:SiO₂=85:15) with a thickness of 45 nm, a recording layer made of PtOx with a thickness of 4 nm, a third dielectric layer made of ZnS—SiO₂ (ZnS:SiO₂=85:15) with a thickness of 45 nm, and a light transmitting layer with a thickness of 0.1 mm, all of which were formed in this order on a polycarbonate substrate. Recording marks were sequentially formed with different graduated powers of the recording laser beam on the super-resolution optical recording medium as in Example 1. As a result, the shape of a recording mark having good CNR (>35 dB) at reproduction was approximately the same as that produced in Example 1.

What is claimed is:

1. An information recording method for irradiating with a recording laser beam a super-resolution optical recording medium which has at least a substrate and a recording layer, a super-resolution layer, and a light transmitting layer on the substrate so that a recording mark and a space, each having a size depending on a modulation code corresponding to information to be recorded, are formed while at least a shortest mark and space corresponding to the modulation code have a size equal to or less than a resolution limit of a reproducing optical system and can be reproduced in the reproducing optical system, wherein
the recording layer is made from a material capable of changing its optical constant and volume when irradiated with the recording laser beam, and is irradiated with the recording laser beam so that the space having the size equal to or less than the resolution limit has a crescent shape when plan view from top surface and a convex section when viewed in a direction normal to a track.

2. A super-resolution optical recording medium, comprising:
at least a substrate, a recording layer, a super-resolution layer, and a light transmitting layer on the substrate; and
a recording mark and a space, each having a size depending on a modulation code corresponding to information to be recorded, wherein at least a shortest mark and space corresponding to the modulation code is recorded so as to have a size equal to or less than a resolution limit of a reproducing optical system and so as to be reproduced in the reproducing optical system, wherein
the space having the length equal to or less than the resolution limit of the optical reproducing system is formed to have a crescent shape when plan view from top surface and a convex section when viewed in a direction normal to a track.
